(19) United States
(12) Patent Application Publication
(10) Pub. No.: US 2015/0128036 A1
(43) Pub. Date: May 7, 2015

(54) METHOD, APPARATUS AND ELECTRONIC DEVICE FOR MOVING TARGET ELEMENT

(71) Applicant: TENCENT TECHNOLOGY (SHENZHEN) COMPANY LIMITED, Shenzhen (CN)

(72) Inventors: HUANHUAN XU, Shenzhen (CN); GUO ZHENG, Shenzhen (CN); BO PENG, Shenzhen (CN); JIE DENG, Shenzhen (CN); LILI XIANG, Shenzhen (CN); JIE YU, Shenzhen (CN); GANG LIU, Shenzhen (CN); CHAO FENG, Shenzhen (CN)

(73) Assignee: TENCENT TECHNOLOGY (SHENZHEN) COMPANY LIMITED

(21) Appl. No.: 14/591,579

(22) Filed: Jan. 7, 2015

Related U.S. Application Data
(63) Continuation of application No. PCT/CN2014/079344, filed on Jun. 6, 2014.

(30) Foreign Application Priority Data
Oct. 22, 2013 (CN) 2013-10499885.X

(51) Int. Cl. G06F 3/0486; G06F 3/0481; G06F 3/01; G06F 3/0484

(52) U.S. Cl. CPC G06F 3/0486; G06F 3/04842; G06F 3/04812; G06F 3/016
USPC 715/702; 715/769

(57) ABSTRACT

Methods, apparatus and electronic devices for moving a target element are provided herein. An exemplary method can be implemented on an electronic device having a display unit. The display unit can display a display interface. A selection signal can be received. A state of a target element on the display interface can be updated as a selected state according to the selection signal. A movement signal linked after the selection signal can be received. A notification message of a target location can be displayed following the movement signal on the display interface. A confirmation signal linked after the movement signal can be received. The target element can be moved to the target location based on the confirmation signal.

### CROSS-REFERENCES TO RELATED APPLICATIONS

This application is a continuation application of PCT Patent Application No. PCT/CN2014/079344, filed on Jun. 6, 2014, which claims priority to Chinese Patent Application No. 201310499885.X, filed on Oct. 22, 2013, the entire contents of which are incorporated herein by reference.

### FIELD OF THE DISCLOSURE

The present disclosure generally relates to computer technology and, more particularly, relates to methods, apparatus and electronic devices for moving target element.

### BACKGROUND

In an electronic device, data objects of the same type are usually distinguished and operated by displaying various identical or similar target elements. For example, if data objects of the same type are application programs or files, the data objects can be distinguished and operated by displaying icons that are all round-shaped or square-shaped. If data objects of the same type are pieces in a board game, the data objects can be distinguished and operated by displaying pieces that are all round-shaped.

When multiple target elements are displayed on the same display interface, there may be a need to move the target elements. For example, when multiple icons are displayed on a desktop, there is a need to move an icon from a current location on the desktop to a target location. When multiple pieces are displayed on a board, e.g., a chessboard, there is a need to move a piece from a current location on the chessboard to a target location on the chessboard.

Existing methods for moving target elements include a click-to-select style and a drag style. The existing methods have at least the following problems. In the click-to-select style, often the target location is not shown on the display interface. For example, on the desktop of a mobile phone, locations where icons can be placed are usually not specifically shown. Thus, it is very easy to move the target element to an incorrect target location. In the drag style, the target location can be blocked by a finger during a dragging process. Thus, it is also very easy to move the target element to an incorrect target location. In other words, the existing methods for moving target element have a high error rate during the process of moving target element. As a result, the operating process can consume a long time and can reduce the lifetime of the devices, especially for battery-powered electronic devices.

### BRIEF SUMMARY OF THE DISCLOSURE

One aspect of the present disclosure includes methods for moving a target element. An exemplary method can be implemented on an electronic device having a display unit. The display unit can display a display interface. A selection signal can be received. A state of a target element on the display interface can be updated as a selected state according to the selection signal. A movement signal linked after the selection signal can be received. A notification message of a target location can be displayed following the movement signal on the display interface. A confirmation signal linked after the movement signal can be received. The target element can be moved to the target location based on the confirmation signal.

Another aspect of the present disclosure includes apparatus for moving a target element. An exemplary apparatus can include a first receiving module, a state-updating module, a second receiving module, a notification-displaying module, a third receiving module, and an element-moving module. The first receiving module is configured to receive a selection signal. The state-updating module is configured to update a state of a target element on a display interface to a selected state according to the selection signal received by the first receiving module. The second receiving module is configured to receive a movement signal linked after the selection signal received by the first receiving module. The notification-displaying module is configured to display a notification message of a target location on the display interface following the movement signal. The third receiving module is configured to receive a confirmation signal linked after the movement signal. The element-moving module is configured to move the target element to the target location based on the confirmation signal.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the disclosure.

FIG. 1A depicts a flow diagram of an exemplary method for moving a target element in accordance with various disclosed embodiments;

FIG. 1B is an illustration for displaying a notification message of a target location in accordance with various disclosed embodiments;

FIG. 2A depicts a flow diagram of another exemplary method for moving a target element in accordance with various disclosed embodiments;

FIG. 2B is an illustration for selecting a target element in accordance with various disclosed embodiments;

FIG. 2C is an illustration for a target element in a selected state in accordance with various disclosed embodiments;

FIG. 2D is an illustration for moving a target element in accordance with various disclosed embodiments;

FIG. 2E(a) is an illustration for displaying a transparent target element in accordance with various disclosed embodiments;

FIG. 2E(b) is an illustration for displaying a transparent target element in accordance with various disclosed embodiments;

FIG. 2F depicts a flow diagram of another exemplary method for moving a target element in accordance with various disclosed embodiments;

FIG. 2G is an illustration for displaying at least one candidate target location in accordance with various disclosed embodiments;

FIG. 2H is an illustration for indicating a target location in accordance with various disclosed embodiments;

FIG. 2I depicts a flow diagram of another exemplary method for moving a target element in accordance with various disclosed embodiments;

FIG. 2J is an illustration for a target element being placed on another target element in accordance with various disclosed embodiments;

FIG. 2K is an illustration for a target element returning to an original location in accordance with various disclosed embodiments;

FIG. 3A depicts a flow diagram of another exemplary method for moving a target element in accordance with various disclosed embodiments;

FIG. 3B is an illustration for selecting a target element in accordance with various disclosed embodiments;

FIG. 3C is an illustration for a target element in a selected state in accordance with various disclosed embodiments;

FIG. 3D is an illustration for moving a target element in accordance with various disclosed embodiments;

FIG. 4 depicts a structure diagram of an exemplary apparatus for moving a target element in accordance with various disclosed embodiments;

FIG. 5 depicts a structure diagram of another exemplary apparatus for moving a target element in accordance with various disclosed embodiments; and

FIG. 6 depicts a structure diagram of an exemplary electronic device for moving a target element in accordance with various disclosed embodiments.

### DETAILED DESCRIPTION

Reference will now be made in detail to exemplary embodiments of the disclosure, which are illustrated in the accompanying drawings.

Methods for moving target elements can include a click-to-select style and a drag style. In the click-to-select style, a target element first needs to be clicked on, in order to be selected. Next, a target location is clicked to be selected. The selected target element is then moved to the target location. In the drag style, a target element first needs to be clicked on, in order to be selected. Next, the selected target element is dragged to a target location by pressing and holding down the left button of the mouse or the touch screen. After the left button of the mouse is released, the selected target element is moved to the target location.

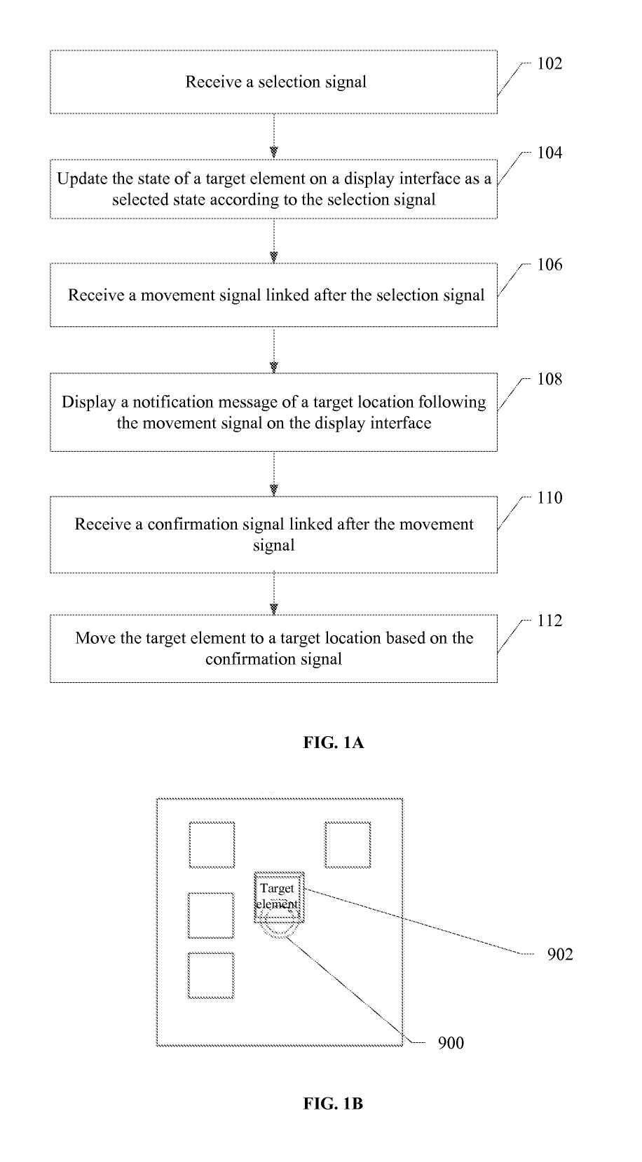

Various embodiments provide methods, apparatus and electronic devices for moving a target element. FIG. 1A depicts a flow diagram of an exemplary method for moving a target element in accordance with various disclosed embodiments. The exemplary method can be implemented on an electronic device. The electronic device can include a terminal that supports mouse operation and/or touch screen operation. The terminal may refer to any appropriate user device with certain computing capabilities, e.g., a personal computer (PC), a work station computer, a hand-held computing device (e.g., a tablet), a mobile terminal (e.g., a mobile phone or a smart phone), or any other appropriate client-side computing device. The method can include the following exemplary steps.

In Step 102, a selection signal is received. In Step 104, a certain target element on a display interface is updated to a selected state according to the selection signal.

As used herein, ‘a selected state’ refers to a state or status of a target element that indicates the target element is selected according to the selection signal. ‘Changing to a selected state’ can refer to any element changing from a non-selected state (i.e., a state in which the element is not selected), to a selected state. The selected state may be indicated via various processes including, e.g., displaying the target element using a certain display state. A display state can refer to appearance, behavior, or any other feature related to how a target element is displayed.

In Step 106, a movement signal that is linked after the selection signal is received. In Step 108, following the movement signal, notification message of a target location is displayed on the display interface.

As used herein, a second signal being linked after a first signal refers to a second signal that is linked to a first signal and chronologically follows the first signal. That is, the second signal occurs immediately after, or for a certain period of time after the first signal occurs.

The notification message can be used to indicate a location the target element is to be moved to, when the current movement signal changes to a confirmation signal. The movement signal can include a signal triggered by a mouse movement, or a finger-dragging signal received on the touch screen. Because the movement signal can be changed dynamically, the notification message can be changed dynamically following the movement signal, i.e., according to the movement signal.

For example, FIG. 1B is an illustration for displaying a notification message of a target location in accordance with various disclosed embodiments. The dotted ring 900 as shown in FIG. 1B is a notification message of a target location displayed on a display screen. The target element as shown in FIG. 1B is a square-shaped piece 902.

Referring back to FIG. 1A, in Step 110, a confirmation signal that is linked after the movement signal is received. In Step 112, the target element is moved to a target location based on the confirmation signal.

As disclosed, in an exemplary method for moving a target element, a selection signal can be received. The state of a target element on a display interface can be updated to a selected state according to the selection signal. A movement signal that is linked after the selection signal can be received. Notification message of a target location can be displayed on the display interface following the movement signal. A confirmation signal that is linked after the movement signal can be received. The target element can be moved to the target location based on the confirmation signal. Therefore, problems of high error rate during a process of moving target element can be solved. Such problems can cause the operating process to consume a long time and reduce the lifetime of battery-powered electronic devices. Thus, by continuously and dynamically displaying notification message of a target location according to changes of a movement signal, a user can intuitively and clearly determine where a target location is during the process of moving. The error rate during the process of moving target element can be reduced. The time consumed by the operating process can be reduced. And consumption of electric power can be reduced.

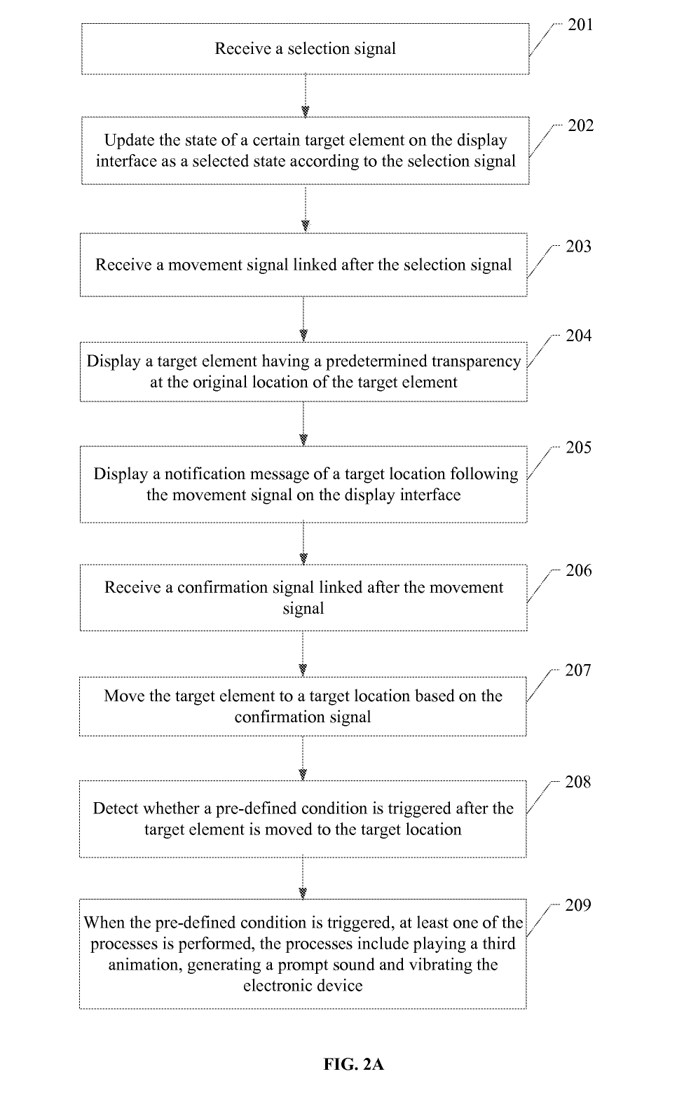

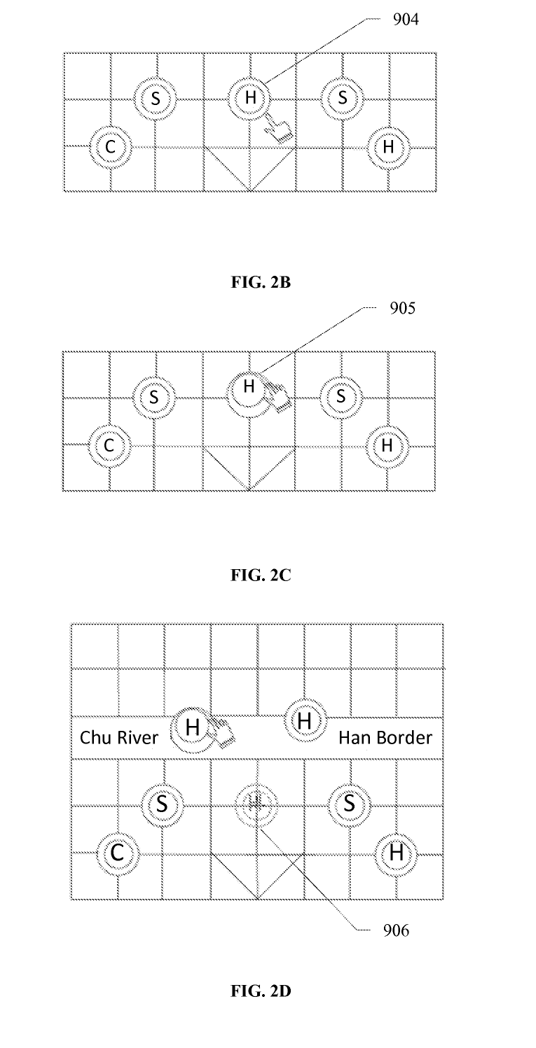

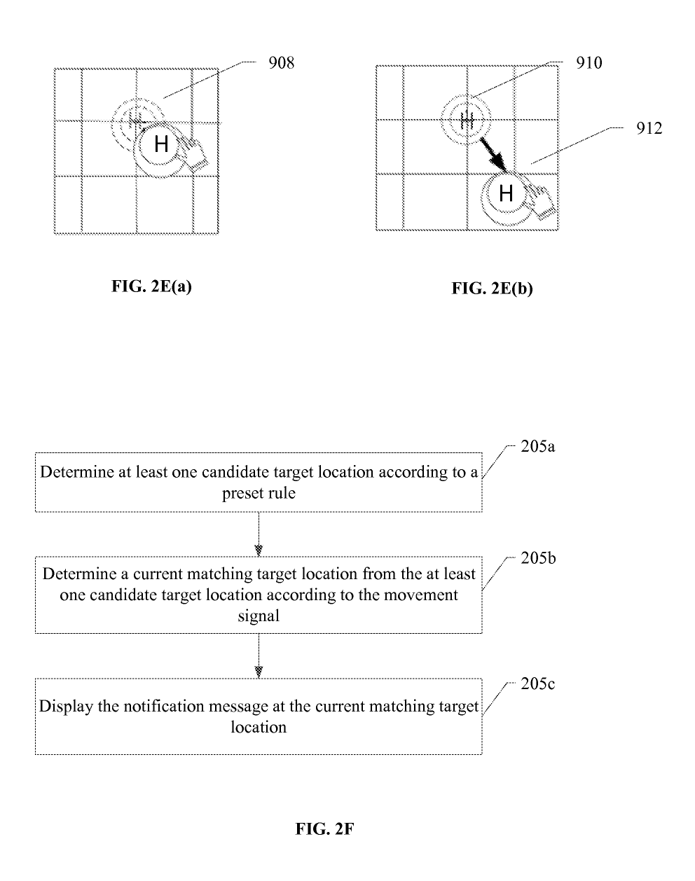

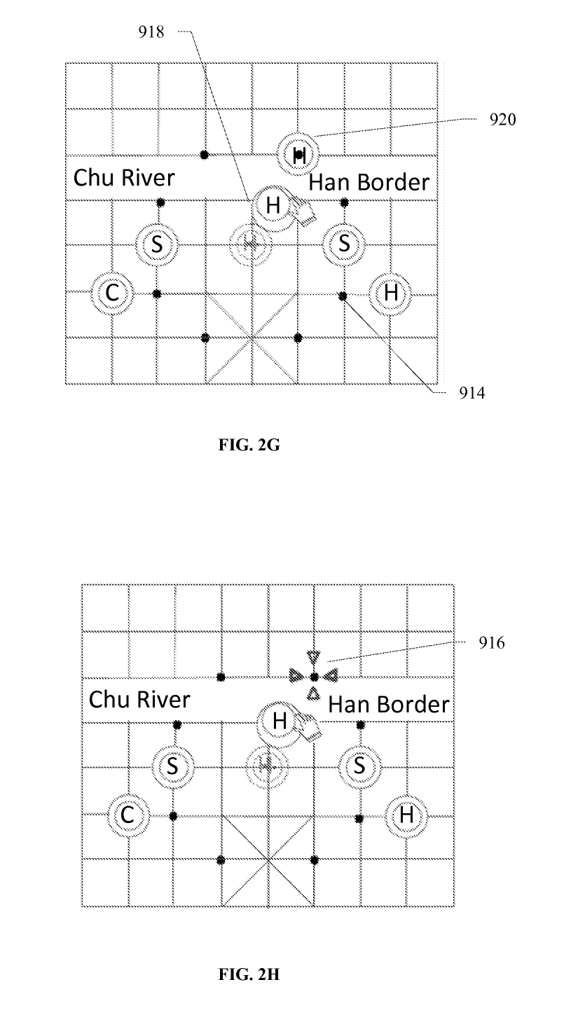

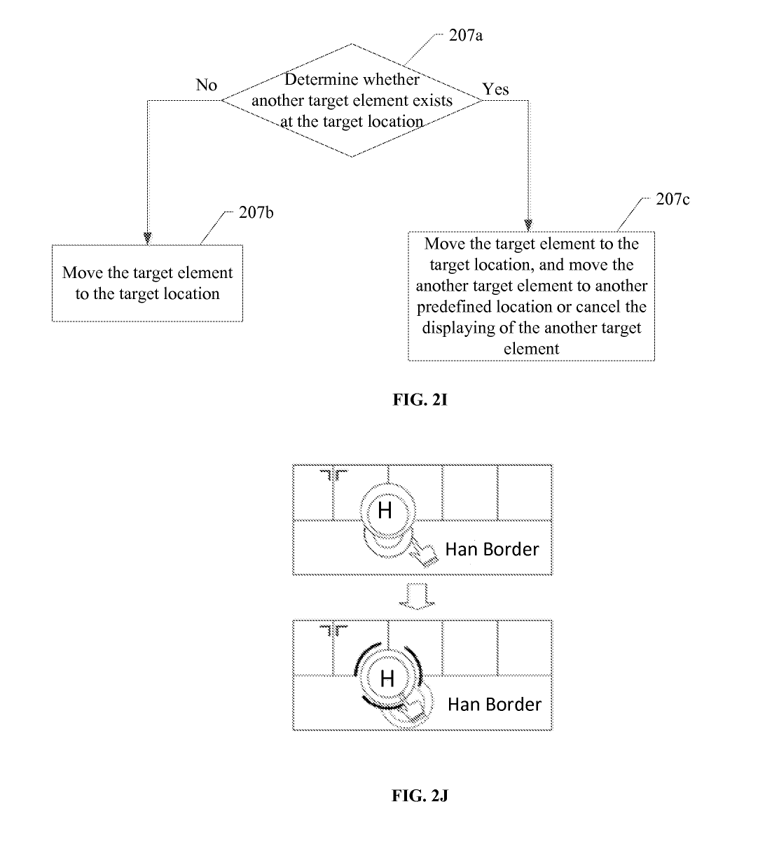

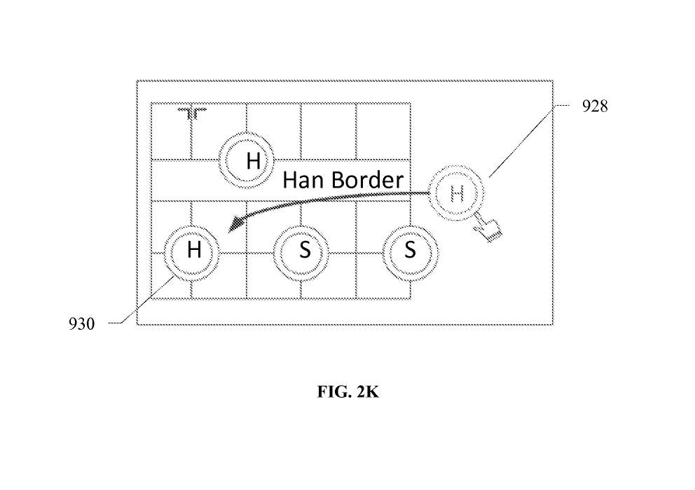

FIG. 2A depicts a flow diagram of another exemplary method for moving a target element in accordance with various disclosed embodiments. For illustrative purposes, the exemplary method is implemented on an electronic device that supports a mouse operation environment. The method can include the following exemplary steps.

In Step 201, a selection signal is received. The electronic device can receive the selection signal triggered by a user. The selection signal can include a clicking signal triggered at a location indicated by a cursor. In other words, the selection signal can include a signal triggered via a mouse clicking on a location of a cursor on a display interface of the electronic device.

For example, in a practical application, on a certain display interface of the electronic device, when a mouse clicks on an icon of a certain application program on the display interface, the icon is thus selected. In another example, in a board game, FIG. 2B is an illustration for selecting a target element in accordance with various disclosed embodiments. As shown in FIG. 2B, there are multiple chess pieces on a game board. On the game board, a curser on a display interface of the electronic device is changed to a hand-shaped cursor, i.e. having a hand shape. When the hand-shaped cursor is moved onto a piece 904 labeled “H” (i.e., “horse”, or Chinese character “ [symbol] ”), a left button of the mouse can be clicked. Correspondingly, the electronic device can receive the selection signal of selecting the piece labeled “horse”.

For illustrative purposes, the application program or the board game can be a Chinese chess game, as shown in FIG. 2B-2E, 2G-2K, 3B-3D, though any kinds of appropriate application programs or board games (e.g., other chess games such as an international chess game) can be encompassed herein according to various embodiments. Chess pieces and game board used in a Chinese chess game are labeled with terms that are Chinese characters having corresponding meanings in English. For example, in Chinese chess game, Chinese character “ [symbol] ” means “horse”, Chinese character “ [symbol] ” means “soldier”, Chinese character “ [symbol] ” means “cannon”, Chinese character “ [symbol] ” means “Chu River”, and Chinese character “ [symbol] ” means “Han border”. In various figures in the present disclosure that are illustrations for a game board or chess board, a chess piece of “horse” is labeled as “H”, a chess piece of “soldier” is labeled as “S”, and a chess piece of “cannon” is labeled as “C”. As used herein, whenever in examples including Chinese chess games, ‘chess piece’ can be used interchangeably with ‘piece’, and ‘game board’ can be used interchangeably with ‘chess board’ or ‘board’.

In Step 202, the state of a certain target element on the display interface is updated to a selected state according to the selection signal. After receiving the selection signal, the electronic device can change a certain target element on the display interface to a selected state according to the selection signal.

The target element can include an element displayed on the display interface of the electronic device, including, e.g., icons, folders, images, or pieces in a board game. The selected state can include multiple states, e.g., changing the shape of the target element, enlarging the target element, and/or shrinking the target element. The selected state can include a display state in which the cursor and the target element pointed to by the cursor are changed into a hand shape grabbing the target element. Such changing can be implemented by the electronic device.

A predetermined distance and a predetermined angle can be maintained between the target element grabbed by the hand-shaped cursor and the display interface. In various embodiments, a hand shape grabbing a target element can refer to a hand shape that grabs the target element and lifts the target element, such that the predetermined distance and the predetermined angle can be maintained between the grabbed target element and the display interface.

In one example, in a practical application, on a display screen of the electronic device, a cursor can select an icon. In order to distinguish the selected icon from non-selected icons, the selected icon can be enlarged and suspended.

In another example, FIG. 2C is an illustration for a target element in a selected state in accordance with various disclosed embodiments. As shown in FIG. 2C, in a board game, the target element is a (chess) piece labeled “horse”. The cursor pointing to the piece labeled “horse” (e.g., as shown in FIG. 2B) can be changed into the display state including a hand shape grabbing the piece 905, which resembles a real hand grabbing the piece labeled “horse”. Further, to distinguish the piece labeled “horse” from other pieces on the board, a predetermined distance and a predetermined angle can be maintained between the piece labeled “horse” and the board, as if the piece labeled “horse” has been “grabbed” by a hand to be suspended “above” the board, such that human eyes can distinguish the difference between the piece labeled “horse” and other pieces on the board.

In Step 203, a movement signal that is linked after the selection signal is received. The electronic device can receive the movement signal linked after the selection signal. The movement signal can refer to a signal of cursor movement caused by moving the mouse. At this time, the cursor that is moved under the movement signal can still be changed to the display state including a hand shape grabbing the piece (e.g., as shown in FIG. 2C).

During the process of moving the target element, the left button of the mouse does not need to be held down continuously. In other words, when the user releases the left button of the mouse, the display state in which the cursor pointing to the target element can be kept as a hand shape grabbing the piece, and be displayed on the display interface. In various embodiments, the display interface can be displayed on a displayed screen of the electronic device. The display state does not have to disappear due to the release of the left button of the mouse, and can move with the movement of the cursor, similar to typical operations of mouse movement.

In Step 204, a target element having a predetermined transparency is displayed at or on the original location of the target element. The electronic device can display a target element having a predetermined transparency at the original location of the target element.

The original location can refer to the location of the target element on the display interface before the target element is selected by the cursor. A target element having a predetermined transparency can refer to a target element that is displayed at the original location of the target element, has a shape similar to or the same as the shape of the target element selected by the cursor, and has a transparency in order to identify the original location of the target element. Thus, the user can know the original location of the target element.

In one example, on the display interface of the electronic device, after an icon selected by the cursor leaves the original location, i.e., leaves the location the icon is previously located, an icon identical to the selected icon and having a transparency can be displayed at the original location.

In another example, FIG. 2D is an illustration for moving a target element in accordance with various disclosed embodiments. As shown in FIG. 2D, in a board game, the dashed lines depict a piece labeled “horse” (or “H”) 906 that has a transparency at the original location of the target element. The piece labeled “horse” having a transparency is shown in FIG. 2D using dashed lines.

Step 204 can include, but is not limited to, the following exemplary sub-steps. In Sub-step 1, a distance from a location indicated by the movement signal to the original location is calculated. A location indicated by the movement signal can refer to a location of the target element on the display interface during the process of moving.

In Sub-step 2, it is determined whether the distance reaches a predetermined threshold value. In Sub-step 3, when the distance is determined not to reach the predetermined threshold value, a target element having a dynamic transparency can be displayed at the original location. That is, in this case, the predetermined transparency can be a dynamic transparency. The distance and the dynamic transparency can have a negative correlation therebetween. That is, the distance can have a negative correlation with the dynamic transparency.

The negative correlation between the distance and the dynamic transparency can include the following relationship. When the distance is shorter, the transparency of the target element having the predetermined transparency displayed on the display interface can be higher. When the distance is longer, the transparency of the target element having the predetermined transparency displayed on the display interface can be lower, i.e., the target element having the predetermined transparency can be clearer, i.e., more clearly displayed or displayed with more clarity.

In Sub-step 4, when the distance is determined to reach the predetermined threshold value, a target element having a static transparency can be displayed at the original location. That is, in this case, the predetermined transparency can be a static transparency. The static transparency can be a predefined value. A static transparency can refer to that, when the distance from the location indicated by the movement signal to the original location reaches or exceeds the predetermined threshold value, the transparency of the target element having the predetermined transparency displayed at the original location no longer changes and is kept to be the predefined value.

For example, in practical applications, on the display interface of the electronic device, when an icon of an application program is moved away from the original location by a longer distance, an icon of the application program having a transparency at the original location of the icon of the application program can be clearer.

In another example, FIGS. 2E(a)-2E(b) are illustrations for displaying a transparent target element in accordance with various disclosed embodiments. In FIGS. 2E(a)-(b), dashed lines and font weight for pieces 908 and 910 are used for indicating transparency. As shown in FIG. 2E(a), in a board game, the transparency of a piece 908 at the original location is not very high, and the piece does not appear very clear. As shown in FIG. 2E(b), with the location 912 indicated by the movement signal moving farther away from the original location, the transparency of the piece 910 at the original location becomes lower, and the piece can thus appear clearer.

In Step 205, a notification message of a target location following the movement signal is displayed on the display interface. The electronic device can display the notification message of the target location on the display interface following the movement signal, i.e., according to the movement signal. The notification message can be used to indicate a location the target element to be moved to when the current movement signal changes to a confirmation signal.

In various embodiments, when the notification message of a target location is displayed following the movement signal, notification message of a certain target location is displayed and the certain target location is a location determined according the movement signal and based on certain criteria. For example, when there are one or more candidate target locations to place the target element during moving of the target element using the movement signal, a candidate target location closest to the target element can have corresponding notification message displayed.

FIG. 2F depicts a flow diagram of another exemplary method for moving a target element in accordance with various disclosed embodiments. As shown in FIG. 2F, Step 205 can include the following exemplary sub-steps.

In Sub-step 205a, at least one candidate target location is determined according to preset rule(s). The electronic device can determine at least one candidate target location according to a preset rule. The at least one candidate target location can refer to location(s) on the display interface where the target element can be dropped (i.e., placed) and the location(s) that follows the preset rule. Corresponding notification message may or may not be displayed at the candidate target location(s).

As used herein, following a preset rule refers to being consistent with, matching, obeying or complying with the preset rule. A preset rule can refer to any rule for the application program, e.g., a board game. For example, a preset rule can include a placement rule for a piece, a movement rule for a piece, and/or other suitable rules for operating a piece.

In various embodiments, a process of placing a piece at a location on the display interface of any application program, e.g., on a board during a game, can be displayed such that the piece appears to fall or be dropped on the location on the board. Therefore, wherever applicable, unless other specified, ‘placing a piece’ can be used interchangeably with ‘dropping a piece’.

For example, in a board game, a notification message of a candidate target location can be used as a prompt for moving a piece. FIG. 2G is an illustration for displaying at least one candidate target location in accordance with various disclosed embodiments. The black dots, e.g., 914, as shown FIG. 2G can indicate locations that follow the placement rule for the piece labeled “horse” or “H” 918. A piece 920 on a black dot illustrates that the piece 918 can be moved to the location of a black dot with the movement signal, and the black dot can still be visible.

Referring to FIG. 2F, in Sub-step 205b, a current matching target location is determined from the at least one candidate target location according to the movement signal. During the movement of the target element, the electronic device can determine the current matching target location from the at least one candidate target location according to the movement signal, i.e., by following the movement signal. That is, from the at least one candidate target location, a candidate target location adjacent to, or closest to, the target element can be determined to be the current matching target location.

In Sub-step 205c, the notification message is displayed at the current matching target location. The electronic device can display the notification message at the current matching target location. The notification message can include, e.g., a graphic mark or shape mark, an arrow mark, a lightening (or flashing or twinkle) mark, an animation effect, or a combination thereof.

For example, in practical applications, on the display interface of the electronic device, an icon of an application program can be moved to a location where there are no other icons. The location can follow a rule for displaying icons on the display interface of the electronic device, and notification message can thus be displayed around the location as triangle arrow marks.

In another example, FIG. 2H is an illustration for indicating a target location in accordance with various disclosed embodiments. In a board game, the triangle arrow marks 916 as shown in FIG. 2H can be the notification message displayed at the current matching target location.

Referring back to FIG. 2A, in Step 206, a confirmation signal that is linked after the movement signal is received. The electronic device can receive the confirmation signal linked after the movement signal. A confirmation signal can refer to a signal triggered at a location on the display interface where the cursor instructs the target element to be placed. In other words, a confirmation signal can refer to a signal of the cursor instructing the target element to be placed at a certain location, for example, via clicking the left button of the mouse at the location on the display interface.

After the electronic device receives the confirmation signal linked after the movement signal, when the current matching target location does not exist, the target element can remain at the original location. In other words, there is no location to place the target element while following the preset rule. In this case, when the user clicks on a location on the display interface that does not match the preset rule, and the target element cannot be placed at the location, the target element can be returned to the original location, i.e., remain at the original location.

For example, in practical applications, on the display interface of the electronic device, an icon of an application program is to be moved to a certain location that does not follow a rule for displaying the icon. Thus, the icon of the application program cannot be placed at the location, and is returned to the original location.

In another example, in a board game, similar to an error feedback operation, when a piece labeled “horse” is to be moved to an adjacent intersection, but the location, i.e., the adjacent intersection, does not match movement rule of the piece labeled “horse”. Thus, the piece labeled “horse” cannot be placed at the location, and is returned to the original location. An intersection can refer to a location where a horizontal line and a vertical line intersect on a board, e.g., a Chinese chess board. In various embodiments, the current location can include an intersection. An adjacent intersection can refer to an intersection immediately next to the current location.

In Step 207, the target element is moved to a target location based on the confirmation signal. The electronic device can move the target element to a target location based on the confirmation signal. For example, after receiving the confirmation signal linked after the movement signal, the electronic device can move the target element to a target location based on the confirmation signal, when there is a current matching target location. That is, the current matching target location can be the target location that the target element is moved to.

For example, FIG. 2I depicts a flow diagram of another exemplary method for moving a target element in accordance with various disclosed embodiments. As shown in FIG. 2I, Step 207 can further include the following exemplary sub-steps.

In Sub-step 207a, it is determined whether another target element exists at the target location. The electronic device can determine whether another target element exists at the target location. Whether another target element exists can refer to whether another element exists at the target location where the target element is to be placed, e.g., whether another icon exists at a location where an icon of an application program is to be placed. The ‘another element’ is different from the target element that is previously selected and currently to be moved to the target location.

In Sub-step 207b, when it is determined that no other target element exists at the target location, the target element is moved to the target location. Optionally, before the target element is moved to the target location, a process of displaying a first animation can be included. The first animation can contain contents including, e.g., the target element being dropped onto the target location.

After the target element is moved to the target location, the following steps can be further included. Notification message can be displayed at the original location of the target element and/or on a moving track of the target element. The notification message can include a graphic mark or shape mark, an arrow mark, a lightening (or flashing or twinkle) mark, an animation effect, or a combination thereof. Similar to the purpose of displaying a target element having a transparency at the original location of the target element, the notification message can be displayed for the user to know locations on the display interface of the original location of the target element and/or the moving track of the target element.

In Sub-step 207c, when it is determined that another target element exists at the target location, the target element is moved to the target location, and the another target element is moved to another predefined location or the displaying of this another target element is cancelled. Optionally, before the target element is moved to the target location and this another target element is moved to the another predefined location or the displaying of the another target element is cancelled, the electronic device can display a second animation.

The second animation can include the following contents. The target element is placed or falls on the another target element. The another target element can be withdrawn from between the target location and the target element. The another target element that is withdrawn can be moved to the another predefined location or the displaying of the another target element can be cancelled. The target element is placed on the target location.

In one example, in practical applications, on the display interface of the electronic device, an icon of an application program can be moved to a location where another icon exists. When the icon of the application program is placed on the location, the another icon that is previously at the location can be moved to another location that follows a preset rule, or can directly disappear from the display interface, or can be moved to another display interface of the electronic device.

In another example, Step 207c can be used for an operation of capturing pieces, cancelling out pieces, or exchanging pieces in a board game. FIG. 2J is an illustration for a target element being placed on another target element in accordance with various disclosed embodiments. As shown in FIG. 2J, a captured piece is withdrawn from beneath a piece labeled “horse”.

Optionally, when another target element previously exists at the target location, after the target element is moved to the target location, the notification message can be displayed at the original location of the target element and/or on a moving track of the target element, for the user to know locations on the display interface of the original location of the target element and/or the moving track of the target element.

In Step 208, it is detected whether a pre-defined condition is triggered after the target element is moved to the target location. The electronic device can detect whether a pre-defined condition is triggered after the target element is moved to the target location.

For example, with movement of the target element, the icons of application program(s) on the display interface of the electronic device reach a threshold value that the display interface can display. In this case, a certain pre-defined condition can be triggered. In another example, in a board game, the pre-defined condition can include an ‘in-check’ situation (i.e., the enemy or opponent player has delivered a check), a checkmate situation, or a piece-capturing operation.

In Step 209, when it is detected that a pre-defined condition is triggered after the target element is moved to the target location, at least one of the following processes is performed. The processes include playing a third animation, generating a prompt sound and vibrating the electronic device.

The third animation can contain contents including, e.g., displaying pre-defined character(s), shaking the display interface (e.g., making the display interface vibrate), and/or shaking a predetermined region on the display interface. In one embodiment, the third animation can include displaying pre-defined character(s), and shaking the display interface or a predetermined region on the display interface.

For example, with movement of the target element, when the icons of application program(s) on the display interface of the electronic device reach a threshold value that the display interface can display, i.e., the number of icons reaches the threshold value and the display interface cannot display any more icons, the electronic device can vibrate.

In another example, in a board game, the pre-defined condition can include an ‘in-check’ situation (i.e., the enemy or opponent player has delivered a check), a checkmate situation, or a piece-capturing operation. In the ‘in-check’ situation, the display interface, i.e., the game interface of both players can be shaken and a prompt sound of ‘in-check’ can be generated. In the checkmate situation, the display interface, i.e., the game interface of both players can be shaken and a prompt sound of ‘checkmate’ can be generated.

Optionally, during movement of the target element, when the user desires to operate an element outside the display interface of the electronic device, the user can move the target element, i.e., the target element that is being moved, to outside the display interface. When the distance between the target element and the display interface is greater than or substantially equal to a preset distance, the target element can be returned to the original location.

For example, in a board game, during the process of moving the target element, when the user desires to operate controls outside the board, the user can move the piece to be at a predefined distance from the boundary of the board. The predefined distance can be, e.g., about the length of the diameter of the piece. In this case, the piece can automatically return to the original location, and the mouse pointer can become a normal hand shape, as shown in FIG. 2K. FIG. 2K is an illustration for a target element 928 returning to an original location 930 in accordance with various disclosed embodiments.

The sequence of above processes in Step 209 can be fixed, altered, or modified as desired. The specific sequence of executing the processes can depend on need of actual applications, without limitation.

As disclosed in the exemplary method for moving a target element, a selection signal can be received. The state of a target element on a display interface can be updated to a selected state according to the selection signal. A movement signal that is linked after the selection signal can be received. A notification message of a target location can be displayed on the display interface following the movement signal. A confirmation signal that is linked after the movement signal can be received. The target element can be moved to the target location based on the confirmation signal. Therefore, problems of high error rate during a process of moving target element can be solved. Such problems can cause the operating process to consume a long time and reduce the lifetime of battery-powered electronic devices. Thus, by continuously and dynamically displaying notification message of a target location according to changes of a movement signal, a user can intuitively and clearly determine where a target location is during a process of moving. The error rate during the process of moving target element can be reduced. The time consumed by the operating process can be reduced. Consumption of electric power can be reduced.

Further, in the methods for moving target element in accordance with various embodiments, by displaying a selected state of the target element, the selected target element can be more easily distinguished from other elements on the display interface. By receiving a movement signal linked after the selection signal while the left button of the mouse does not need to be held down continuously during the process of moving the target element, the left button of the mouse does not need to be held down continuously, and the target element can still be displayed when being moved with the mouse without blocking other elements on the display interface. In addition, by displaying a target element having a predetermined transparency at the original location of the target element, the user can more easily know where the original location of the target element is located on the display interface.

Still further, in the methods for moving target element in accordance with various embodiments, by displaying notification message at a current matching target location, the user can more easily know at which location on the display interface to place the target element currently being moved. By displaying at least one candidate target location, locations matching preset rule(s) can be determined more accurately and quickly. Thus, time can be saved and accuracy can be improved. By keeping the target element at the original location when there is no current matching target location, the target element is not placed at an incorrect location thus to cause confusion on the display interface. By moving the target element to the target location, and by moving another target element from the target location to another predefined location or cancelling the displaying of the another target element, the target element can replace the another target element. Thus, there is no need to delete the another target element or move the another target element again. Complexity of operation can thus be reduced, and time can be saved.

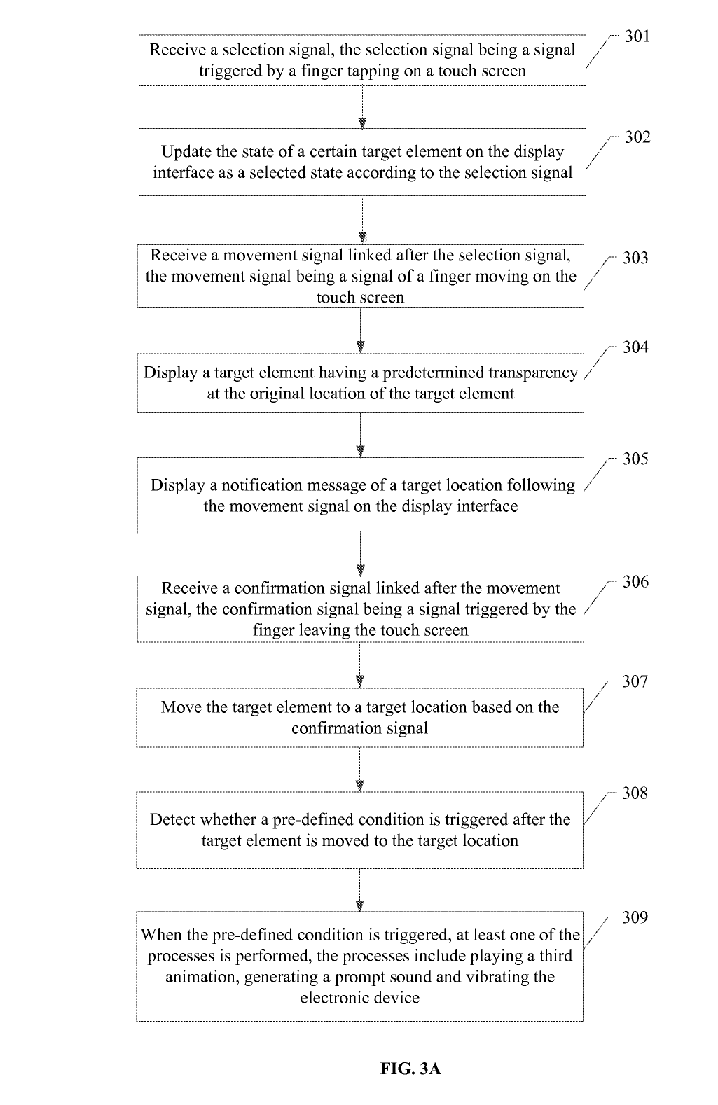

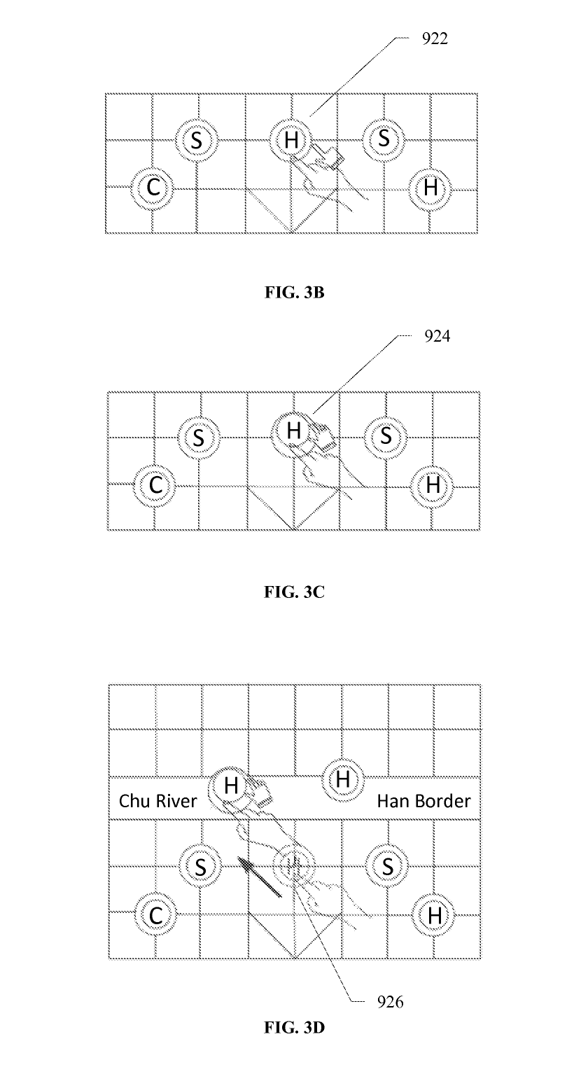

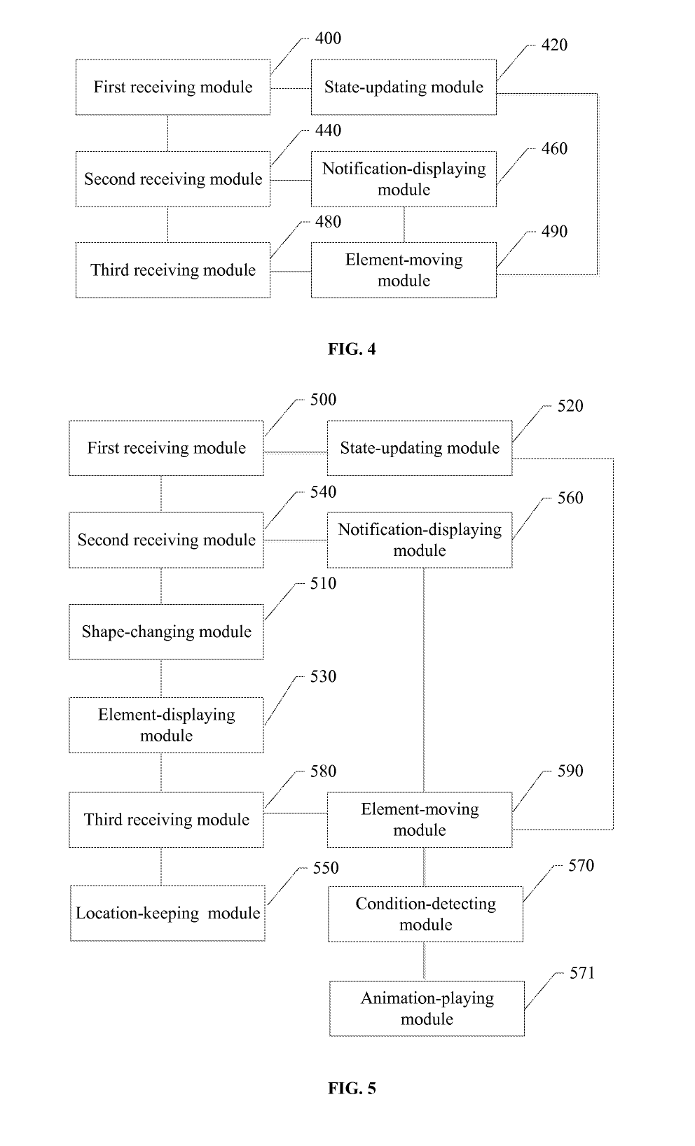

FIG. 3A depicts a flow diagram of another exemplary method for moving a target element in accordance with various disclosed embodiments. The exemplary method can be implemented on an electronic device that has a touch screen. The method can include the following exemplary steps.

In Step 301, a selection signal is received. The selection signal can include a signal triggered by a finger tapping on the touch screen.

The electronic device can receive the selection signal. The selection signal can include a signal triggered by a finger (or other objects) tapping on the touch screen. The electronic device can receive a tapping signal triggered by a finger tapping on a location on the touch screen. In addition, the finger can be held down on the touch screen. In various embodiments, tapping by a finger can also be referred to as clicking by a finger.

For example, in practical applications, on a display interface of the electronic device, when a finger taps on an icon of a certain application program on the display interface of the electronic device, and the finger is held down on the icon of the application program, i.e., without releasing, the icon is thus selected.

In another example, FIG. 3B is an illustration for selecting a target element in accordance with various disclosed embodiments. In a board game, as shown in FIG. 3B, after a finger taps on a piece 922, the finger is held down without releasing.

In Step 302, the state of a target element on the display interface is updated to a selected state according to the selection signal. After receiving the selection signal, the electronic device can change a certain target element on the display interface to a selected state according to the selection signal.

The target element can include an element displayed on the display interface of the electronic device, including, e.g., icons, folders, images, or pieces in a board game. The selected state can include multiple states, e.g., changing the shape of the target element, enlarging the target element, and/or shrinking the target element. The selected state can include a display state in which the cursor and the target element pointed to by the cursor are changed into a hand shape grabbing the target element. Such changing can be implemented by the electronic device. A predetermined distance and a predetermined angle can be maintained between the grabbed target element and the display interface.

In one example, in practical application, on a display screen of the electronic device, a finger can tap on an icon. In order to distinguish the selected icon from non-selected icons, the selected icon can be enlarged and suspended.

In another example, FIG. 3C is an illustration for a target element 924 in a selected state in accordance with various disclosed embodiments. In a chess game, the selected icon can be enlarged and suspended, e.g., as shown in FIG. 3C.

In Step 303, a movement signal linked after the selection signal is received. The movement signal can refer to a signal of a finger moving on the touch screen. The electronic device can receive the movement signal linked after the selection signal. The movement signal can refer to a signal of a finger moving on the touch screen. During the process of moving the finger on the touch screen, the target element can still be displayed in the display state as a hand shape grabbing the piece.

In Step 304, a target element having a predetermined transparency is displayed at the original location of the target element. The electronic device can display a target element having a predetermined transparency at the original location of the target element.

The original location can refer to the location of the target element on the display interface before the target element is tapped by the finger. A target element having a predetermined transparency can refer to a target element that is displayed at the original location of the target element, has a shape similar to or the same as the shape of the target element tapped by the finger, and has a transparency in order to identify the original location of the target element. Thus, the user can know the original location of the target element.

In one example, in actual applications, on the display interface of the electronic device, after an icon tapped by the finger leaves the original location, i.e., leaves the location the icon is previously at, an icon identical to the tapped icon and having a transparency can be displayed at the original location.

In another example, FIG. 3D is an illustration for moving a target element in accordance with various disclosed embodiments. As shown in FIG. 3D, in a board game, the dashed lines depict a piece labeled “horse” 926 having a transparency at the original location of the target element. The piece labeled “horse” having a transparency is shown in FIG. 3D using dashed lines.

For example, Step 304 can include, but is not limited to, the following exemplary sub-steps. In Sub-step 1, a distance from a location indicated by the movement signal to the original location, i.e., a distance between the original location and a location indicated by the movement signal, is calculated. A location indicated by the movement signal can refer to a location of the target element on the display interface during the process of moving.

In Sub-step 2, it is determined whether the distance reaches a predetermined threshold value. In Sub-step 3, when the distance is determined not to reach the predetermined threshold value, a target element having a dynamic transparency can be displayed at the original location. That is, in this case, the predetermined transparency can include a dynamic transparency. The distance and the dynamic transparency can have a negative correlation therebetween.

The negative correlation between the distance and the dynamic transparency can refer to the following relationship. When the distance is shorter, the transparency of the target element having the predetermined transparency displayed on the display interface can be higher. When the distance is longer, the transparency of the target element having the predetermined transparency displayed on the display interface can be lower, i.e., the target element having the predetermined transparency can be clearer, i.e., more clearly displayed or displayed with more clarity.

In Sub-step 4, when the distance is determined to reach the predetermined threshold value, a target element having a static transparency can be displayed at the original location. That is, in this case, the predetermined transparency can include a static transparency. The static transparency can be a predefined value. A static transparency can refer to that, when the distance from the location indicated by the movement signal to the original location reaches or exceeds the predetermined threshold value, the transparency of the target element having the predetermined transparency displayed at the original location no longer changes and is kept to be the predefined value.

For example, in practical applications, on the display interface of the electronic device, when an icon of an application program is moved away from the original location by a longer distance, an icon of the application program having a transparency located at the original location of the icon of the application program can be clearer.

In Step 305, notification message of a target location is displayed on the display interface following the movement signal. The electronic device can display the notification message of the target location on the display interface following the movement signal, i.e., along with or according to the movement signal. The notification message can be used to indicate a location the target element is to be moved to when the current movement signal changes to a confirmation signal.

For example, Step 305 can include the following exemplary sub-steps. In Sub-step 1, at least one candidate target location is determined according to preset rule(s). The electronic device can determine at least one candidate target location according to a preset rule. The at least one candidate target location can refer to location(s) on the display interface where the target element can be dropped (i.e., placed) and the location(s) match the preset rule. Corresponding notification message is, or is not, displayed at the candidate target location(s). For example, in a board game, notification message of a candidate target location can be used as a prompt for moving or a piece.

In Sub-step 2, a current matching target location is determined from the at least one candidate target location, according to the movement signal. During the movement of the target element, the electronic device can determine the current matching target location from the at least one candidate target location according to the movement signal, i.e., by following the movement signal. That is, from the at least one candidate target location, a candidate target location adjacent to the target element can be determined to be the current matching target location.

In Sub-step 3, the notification message is displayed at the current matching target location. The electronic device can display the notification message at the current matching target location. The notification message can include, e.g., a graphic mark or shape mark, an arrow mark, a lightening (or flashing or twinkle) mark, an animation effect, or a combination thereof.

For example, in practical applications, on the display interface of the electronic device, an icon of an application program can be moved to a location where there are no other icons. The location can match a rule for displaying icons on the display interface of the electronic device, and notification message can thus be displayed around the location using triangle arrow marks.

In Step 306, a confirmation signal that is linked after the movement signal is received. The electronic device can receive the confirmation signal linked after the movement signal. A confirmation signal can refer to a signal triggered at a location on the display interface where the finger leaves the touch screen. In other words, a confirmation signal can refer to a signal triggered at a location on the display interface that the target element is instructed to be placed when the finger leaves the touch screen.

After the electronic device receives the confirmation signal linked after the movement signal, when there is no current matching target location, the target element can remain at the original location. In other words, there is no location to place the target element while matching the preset rule. In this case, when the user releases the finger at a location on the display interface that does not match the preset rule, and the target element cannot be placed at the location, the target element can be returned to the original location, i.e., remain at the original location.

For example, in practical applications, on the display interface of the electronic device, an icon of an application program is to be moved to a certain location that does not match a rule for displaying the icon. Thus, the icon of the application program cannot be placed at the location, and is returned to the original location.

In another example, in a board game, similar to an error feedback operation, when a piece is to be moved to a location that does not match movement rule of the piece, the piece cannot be placed at the location, and is returned to the original location.

In Step 307, the target element is moved to a target location based on the confirmation signal. The electronic device can move the target element to a target location based on the confirmation signal. The finger can be released, i.e., can leave the touch screen in order to place the target element at the target location. For example, after receiving the confirmation signal linked after the movement signal, when there is a current matching target location, the electronic device can move the target element to the target location based on the confirmation signal. That is, the current matching target location can be the target location that the target element is moved to.

For example, Step 307 can further include the following exemplary sub-steps. In Sub-step 1, it is determined whether another target element exists at the target location. The electronic device can determine whether another target element exists at the target location. Whether another target element exists can refer to whether another element exists at the target location where the target element is to be placed, e.g., whether another icon exists at a location where an icon of an application program is to be placed.

In Sub-step 2, when it is determined that no other target element exists at the target location, the target element is moved to the target location. Optionally, before the target element is moved to the target location, a process of displaying a first animation can be included. The first animation can contain contents including, e.g., the target element being dropped onto the target location.

After the target element is moved to the target location, the following steps can be further included. Notification message can be displayed at the original location of the target element and/or on a moving track of the target element. The notification message can include a graphic mark or shape mark, an arrow mark, a lightening (or flashing or twinkle) mark, an animation effect, or a combination thereof. Similar to displaying a target element having a transparency at the original location of the target element, the notification message can be displayed for the user to know locations on the display interface of the original location of the target element and/or the moving track of the target element.

In Sub-step 3, when it is determined that another target element exists at the target location, the target element is moved to the target location, and the another target element is moved to another predefined location or the displaying of the another target element is cancelled. Optionally, before the target element is moved to the target location, and the another target element is moved to the another predefined location or the displaying of the another target element is cancelled, the electronic device can display a second animation.

The second animation can include the following contents. The target element is placed or falls on the another target element. The another target element is withdrawn from between the target location and the target element. The another target element that is withdrawn is moved to the another predefined location or the displaying of the another target element is cancelled. The target element is then placed or dropped on the target location.

In one example, in practical applications, on the display interface of the electronic device, an icon of an application program can be moved to a location where another icon exists. When the icon of the application program is placed on the location, the another icon that is previously at the location can be moved to another location that follows a preset rule, can directly disappear from the display interface, or can be moved to another display interface of the electronic device. In another example, Sub-step 3 can be used for an operation of capturing piece, cancelling out pieces, or exchanging piece in a board game.

In Step 308, it is detected whether a pre-defined condition is triggered after the target element is moved to the target location. The electronic device can detect whether a pre-defined condition is triggered after the target element is moved to the target location.

For example, with movement of the target element, when the icons of application program(s) on the display interface of the electronic device can reach a threshold value that the display interface can display, or when an icon of an application program is long pressed, a certain pre-defined condition can be triggered. In another example, in a board game, the pre-defined condition can include an ‘in-check’ situation (i.e., the enemy or opponent player has delivered a check), a checkmate situation, or a piece-capturing operation.

In Step 309, when it is detected that a pre-defined condition is triggered after the target element is moved to the target location, at least one of the following processes is performed. The processes include playing a third animation, generating a prompt sound, and vibrating the electronic device.

The third animation can contain contents including, e.g., displaying pre-defined character(s), shaking the display interface (e.g., making the display interface vibrate or tremble), and/or displaying a predetermined region on the display interface.

For example, with movement of the target element, when the icons of application program(s) on the display interface of the electronic device reach a threshold value that the display interface can display, i.e., the number of icons reaches the threshold value and the display interface cannot display any more icons, the electronic device can vibrate. In another example, when an icon of an application program is long pressed, all icons displayed on the electronic device can vibrate.

In another example, in a board game, the pre-defined condition can include an ‘in-check’ situation (i.e., the enemy or opponent player has delivered a check), a checkmate situation, or a piece-capturing operation. In the ‘in-check’ situation, the display interface, i.e., the game interface of both players can be shaken and a prompt sound of ‘in-check’ can be generated. In the checkmate situation, the display interface, i.e., the game interface of both players can be shaken and a prompt sound of ‘checkmate’ can be generated.

Optionally, during movement of the target element, when the user desires to operate an element outside the display interface of the electronic device, the user can move the target element, i.e., the target element that is being moved, to outside the display interface. When the distance between the target element and the display interface is greater than or substantially equal to a preset distance, the target element can be returned to the original location.

For example, in a board game, during the process of moving the target element, when the user desires to operate controls outside the board, the user can move the piece to be at a predefined distance from the boundary of the board. The predefined distance can be, i.e., about the length of the diameter of the piece. In this case, the piece can automatically return to the original location, and the mouse pointer or the hand shape grabbing the piece can becomes a normal hand shape.

Any above processes in Step 309 are not necessarily or strictly executed according to a fixed sequence. The specific sequence of executing the processes can depend on need of actual applications, without limitation.

In one embodiment, during Step 301, when a finger leaves the touch screen after tapping on a target element, the state of the target element on the display interface can be updated to a selected state according to the selection signal. The finger can move the target element by merely tapping on a location to place the target element without sliding the finger.

In another embodiment, when the electronic device supports suspended touch signal, i.e., a hover signal, the suspended touch signal can be used as a movement signal. That is, a finger can leave the touch screen after tapping on a target element, and does not contact the screen. When the finger maintains a predefined hover distance from the screen, according to direction of movement of the figure, the screen can still display the process of the target element moving along with the finger, and notification message can be displayed at the same time, e.g., as shown in FIGS. 2A-2H.

As disclosed, in an exemplary method for moving a target element, a selection signal can be received. The state of a target element on a display interface can be updated to a selected state according to the selection signal. A movement signal that is linked after the selection signal can be received. Notification message of a target location can be displayed on the display interface following the movement signal. A confirmation signal that is linked after the movement signal can be received. The target element can be moved to the target location based on the confirmation signal. Therefore, problems of high error rate during a process of moving target element can be solved. Such problems can cause the operating process to consume a long time and reduce the lifetime of battery-powered electronic devices. Thus, by continuously and dynamically displaying notification message of a target location according to changes of a movement signal, a user can intuitively and clearly determine where a target location is during a process of moving. The error rate during the process of moving target element can be reduced. The time consumed by the operating process can be reduced. And consumption of electric power can be reduced.

Further, in the methods for moving target element in accordance with various embodiments, by displaying a selected state of the target element, the selected target element can be more easily distinguished from other elements on the display interface. In addition, by displaying a target element having a predetermined transparency at the original location of the target element, the user can more easily know where the original location of the target element is located on the display interface.

Still further, in the methods for moving target element in accordance with various embodiments, by displaying notification message at a current matching target location, the user can more easily know at which location on the display interface to place the target element currently being moved. By displaying at least one candidate target location, locations matching preset rule(s) can be found and determined more accurately and quickly. Thus, time can be saved and accuracy can be improved. By keeping the target element at the original location when there is no current matching target location, the target element cannot be placed at an incorrect location to cause confusion on the display interface. By moving the target element to the target location, and by moving another target element from the target location to a another predefined location or cancelling the displaying of the another target element, the target element can replace the another target element. Thus, there is no need to delete the another target element or move the another target element again. Complexity of operation can thus be reduced, and time can be saved.

Various embodiments also provide apparatus for moving a target element. Details of the apparatus can be similar or the same as described above in the methods for moving target element, e.g., as shown in FIGS. 1A-1B, FIGS. 2A-2K, and FIGS. 3A-3D.

FIG. 4 depicts a structure diagram of an exemplary apparatus for moving a target element in accordance with various disclosed embodiments. The apparatus for moving a target element can be implemented by combining software and hardware, and can be part of or all of an electronic device. The apparatus for moving a target element can include a first receiving module 400, a state-updating module 420, a second receiving module 440, a notification-displaying module 460, a third receiving module 480, and/or an element-moving module 490. Certain modules can be omitted and other modules can be included.

The first receiving module 400 is configured to receive a selection signal. The state-updating module 420 is configured to change a certain target element on a display interface to a selected state according to the selection signal received by the first receiving module 400.

The second receiving module 440 is configured to receive a movement signal that is linked after the selection signal received by the first receiving module 400. The notification-displaying module 460 is configured to display notification message of a target location on the display interface following the movement signal received by the second receiving module 440.

The third receiving module 480 is configured to receive a confirmation signal that is linked after the movement signal received by the second receiving module 440. The element-moving module 490 is configured to move the target element, i.e., the target element whose state is updated to the selected state by the state-updating module 420, to the target location displayed by the notification-displaying module 460, according to the confirmation signal received by the third receiving module 480.

As disclosed, using an exemplary apparatus for moving a target element, a selection signal can be received. The state of a target element on a display interface can be updated to a selected state according to the selection signal. A movement signal that is linked after the selection signal can be received. Notification message of a target location can be displayed on the display interface following the movement signal. A confirmation signal that is linked after the movement signal can be received. The target element can be moved to the target location based on the confirmation signal. Therefore, problems of high error rate during a process of moving target element can be solved. Such problem can cause the operating process to consume a long time and reduce the lifetime of battery-powered electronic devices. Thus, by continuously and dynamically displaying notification message of a target location according to changes of a movement signal, a user can intuitively and clearly determine where a target location is during a process of moving. The error rate during the process of moving target element can be reduced. The time consumed by the operating process can be reduced. Consumption of electric power can be reduced.

FIG. 5 depicts a structure diagram of another exemplary apparatus for moving a target element in accordance with various disclosed embodiments. The apparatus for moving a target element can be implemented by combining software and hardware, and can be part of or all of an electronic device. The apparatus for moving a target element can include a first receiving module 500, a state-updating module 520, a second receiving module 540, a notification-displaying module 560, a third receiving module 580, and/or an element-moving module 590. Certain modules can be omitted and other modules can be included.

The first receiving module 500 is configured to receive a selection signal. The state-updating module 520 is configured to change a certain target element on a display interface to a selected state according to the selection signal received by the first receiving module 500.

The second receiving module 540 is configured to receive a movement signal that is linked after the selection signal received by the first receiving module 500. The notification-displaying module 560 is configured to display notification message of a target location on the display interface following the movement signal received by the second receiving module 540.

The third receiving module 580 is configured to receive a confirmation signal that is linked after the movement signal received by the second receiving module 540. The element-moving module 590 is configured to move the target element, i.e., the target element whose state is updated to the selected state by the state-updating module 520, to the target location displayed by the notification-displaying module 560, according to the confirmation signal received by the third receiving module 580.

Optionally, the notification-displaying module 560 can include a location-determining unit, a match-determining unit, and/or a notification-displaying unit. Certain units can be omitted and other units can be included.

The location-determining unit is configured to determine at least one candidate target location according to preset rule(s). The match-determining unit is configured to determine a current matching target location according to the movement signal, from the at least one candidate target location determined by the location-determining unit.

The notification-displaying unit is configured to display the notification message at the current matching target location determined by the match-determining unit. The notification message can include, e.g., a graphic mark or shape mark, an arrow mark, a lightening (or flashing or twinkle) mark, an animation effect, or a combination thereof.

Optionally, the selection signal can include a clicking signal triggered at a location indicated by a cursor. The state-updating module 520 is configured to change the cursor and the target element pointed to by the cursor into a display state in which a hand shape grabs the target element. A predetermined distance and a predetermined angle can be maintained between the grabbed target element and the display interface.

Optionally, the apparatus for moving a target element can further include a shape-changing module 510. The shape-changing module 510 is configured to change the cursor, i.e., the cursor to be moved by the movement signal, into the display state as the hand shape that grabs the target element.

Optionally, the apparatus for moving a target element can further include an element-displaying module 530. The element-displaying module 530 can include a distance-calculating unit, a threshold-value-determining unit, a first displaying unit, and/or a second displaying unit. Certain units can be omitted and other units can be included.

The distance-calculating unit is configured to calculate a distance from a location indicated by the movement signal to the original location. The threshold-value-determining unit is configured to determine whether the distance calculated by the distance-calculating unit reaches a predetermined threshold value.

The first displaying unit is configured to, when the threshold-value-determining unit determines that the distance does not reach the predetermined threshold value, display a target element having a dynamic transparency at the original location. The distance can have a negative correlation with the dynamic transparency. The second displaying unit is configured to, when the threshold-value-determining unit determines that the distance reaches the predetermined threshold value, display a target element having a static transparency at the original location. The static transparency can be a predefined value.

Optionally, the element-moving module 590 can include an element-determining unit, a first moving unit, and/or a second moving unit. Certain units can be omitted and other units can be included.

The element-determining unit is configured to determine whether another target element exists at the target location. The first moving unit is configured to, when the element-determining unit determines that no other target element exists at the target location, move the target element to the target location. The second moving unit is configured to, when the element-determining unit determines that that another target element exists at the target location, move the target element to the target location, and move the another target element to a another predefined location or cancel the displaying of the another target element.

Optionally, the element-moving module 590 can further include a first-animation-displaying unit. The first-animation-displaying unit is configured to display a first animation. The first animation can contain contents including, e.g., the target element being dropped onto the target location.

Optionally, the element-moving module 590 can further include an information-displaying unit. The information-displaying unit is configured to display notification message at the original location of the target element and/or on the moving track of the target element. The notification message can include a graphic mark or shape mark, an arrow mark, a lightening (or flashing or twinkle) mark, an animation effect, or a combination thereof.

Optionally, the element-moving module 590 can further include a second-animation-displaying unit. The second animation can include the following contents. The target element is placed or falls on the another target element. The another target element is withdrawn from between the target location and the target element. The another target element that is withdrawn is moved to the another predefined location or the displaying of the another target element is cancelled. The target element is then placed or dropped on the target location.

Optionally, the apparatus for moving a target element can further include a location-keeping module 550. The location-maintaining module is configured to, when there is not a current matching target location, keep the target element at the original location.

Optionally, the apparatus for moving a target element can further include a condition-detecting module 570 and/or an animation-playing module 571. The condition-detecting module 570 is configured to detect whether a pre-defined condition is triggered after the target element is moved to the target location.

The animation-playing module 571 is configured to, when the pre-defined condition is triggered, perform at least one of the processes that include playing a third animation, generating a prompt sound, and vibrating the electronic device. The third animation can contain contents including, e.g., displaying pre-defined character(s), shaking the display interface (e.g., making the display interface vibrate or tremble), and/or displaying a predetermined region on the display interface.

As disclosed, by using an exemplary apparatus for moving a target element, a selection signal can be received. The state of a target element on a display interface can be updated to a selected state according to the selection signal. A movement signal that is linked after the selection signal can be received. Notification message of a target location can be displayed on the display interface following the movement signal. A confirmation signal that is linked after the movement signal can be received. The target element can be moved to the target location based on the confirmation signal. Therefore, problems of high error rate during a process of moving target element can be solved. Such problems can cause the operating process to consume a long time and reduce the lifetime of battery-powered electronic devices. Thus, by continuously and dynamically displaying notification message of a target location according to changes of a movement signal, a user can intuitively and clearly determine where a target location is during a process of moving. The error rate during the process of moving target element can be reduced. The time consumed by the operating process can be reduced. And consumption of electric power can be reduced.

Further, using the apparatus for moving a target element in accordance with various embodiments, by displaying a selected state of the target element, the selected target element can be more easily distinguished from other elements on the display interface. By receiving a movement signal linked after the selection signal while the left button of the mouse does not need to be held down continuously during the process of moving the target element, the left button of the mouse does not need to be held down continuously and the target element can still be displayed when being moved with the mouse without blocking other elements on the display interface. In addition, by displaying a target element having a predetermined transparency at the original location of the target element, the user can more easily know where the original location of the target element is located on the display interface.

Still further, using the apparatus for moving a target element in accordance with various embodiments, by displaying notification message at a current matching target location, the user can more easily know at which location on the display interface to place the target element currently being moved. By displaying at least one candidate target location, locations matching preset rule(s) can be determined more accurately and quickly. Thus, time can be saved and accuracy can be improved. By keeping the target element at the original location when there is no current matching target location, the target element cannot be placed at an incorrect location to cause confusion on the display interface. By moving the target element to the target location, and by moving another target element from the target location to another predefined location or cancelling the displaying of the another target element, the target element can replace the another target element. Thus, there is no need to delete the another target element or move the another target element again. Complexity of operation can thus be reduced, and time can be saved.

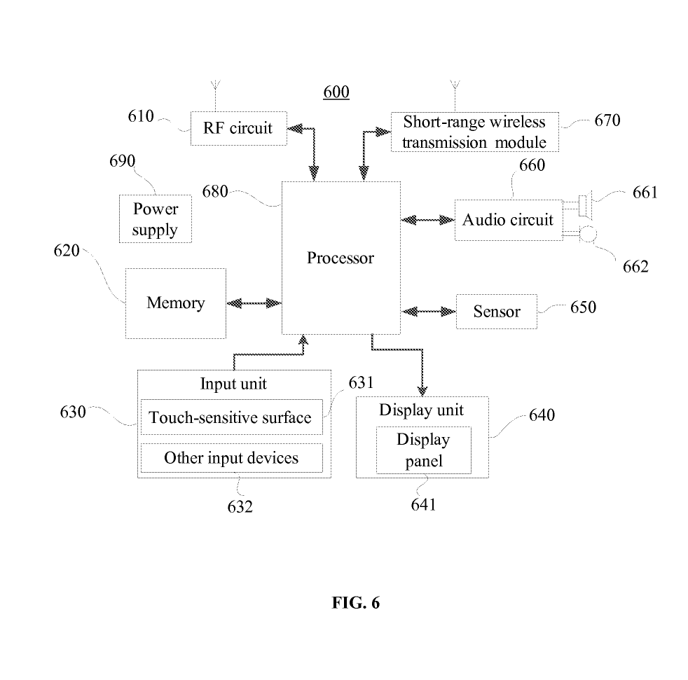

FIG. 6 depicts a structure diagram of an exemplary electronic device for moving a target element in accordance with various disclosed embodiments. The electronic device can be configured to implement the methods for moving target element as described in various disclosed embodiments.

For example, the electronic device 600 may include a radio frequency (RF) circuit 610, a memory 620 including one or more computer-readable storage media, an input unit 630, a display unit 640, a sensor 650, an audio circuit 660, a short-range wireless transmission module 670, a processor 680 including one or more processing cores, a power supply 690, and/or other components. The structure of the terminal depicted in FIG. 6 is for illustrative purposes only and does not limit the electronic device. More or less than the components illustrated in FIG. 6 can be included, certain components can be combined, and arrangement of the components can be different.

The RF circuit 610 can be used to receive and transmit signals during receiving and transmission of information or communication. For example, the RF circuit 610 can be configured to receive base station downlink information to send the same to the one or more processors 680 for processing, and further, to send data related to uplink to the base station. Generally, the RF circuit 610 can include, but is not limited to, antenna, at least one amplifier, a tuner, one or more oscillators, subscriber identity module (SIM) card, transceiver, coupler, low noise amplifier (LNA), duplexer, etc. In addition, the RF circuit 610 can communicate with network and other devices via wireless communication. The wireless communication can use any communication standard or protocol including, but not limited to, Global System of Mobile communication (GSM), General Packet Radio Service (GPRS), Code Division Multiple Access (CDMA), Wideband Code Division Multiple Access (WCDMA), Long Term Evolution (LTE), e-mail, Short Messaging Service (SMS), etc.

The memory 620 is configured to store software programs and/or modules. For example, the memory 620 may include a software program for storing and collecting voice signal, a software program for recognizing keyword, a software program for continuous speech recognition, and/or a software program for setting up reminder items, or any other appropriate programs.

By running or executing the software programs and/or modules stored in the memory 620, and by retrieving data stored in the memory 620, the processor 680 can perform various functions of the electronic device 600 and process data. For example, the functions can include the functions of ‘determining at least one candidate target location according to preset rule(s)’, ‘calculating a distance from a location indicated by the movement signal to the original location’, ‘determining whether the distance reaches a predetermined threshold value’, or any other appropriate functions.

The memory 620 may include a storage program area and a storage data area. The storage program area is configured to store operating systems and application programs required by one or more functions (e.g., sound playback, image playback, etc.) or any other suitable programs for storing. The storage data area is configured to store data created based on usage of the electronic device 600 (e.g., audio data, phone book, etc.). Further, the memory 620 can include high-speed random access memory (RAM) and/or non-volatile memory, e.g., one or more disk storage devices, flash memory devices, and/or other volatile solid-state memory devices. Accordingly, the memory 620 may also include a memory controller to provide the processor 680 with access to the memory 620.

The input unit 630 can be configured to receive inputted numbers or character information, and to generate signal input (e.g., keyboard, mouse, joystick, optical or trackball signal input) related to user settings and functional control. For example, in one embodiment, the input unit 630 may include a touch-sensitive surface 631, and/or other input devices 632.

The touch-sensitive surface 631, also known as a touch screen or touch panel, can be configured to collect touch operations by a user on or near the touch-sensitive surface 631 (e.g., operations on or near the touch-sensitive surface 631 from the user by using finger(s), a stylus, and/or any other suitable objects or accessories), and to drive corresponding connected apparatus according to preset programs. Optionally, the touch-sensitive surface 631 may include two parts including a touch detection apparatus and a touch controller. The touch detection apparatus is configured to detect the user's touch location, detect a signal generated by the touch operation, and send the signal to the touch controller. The touch controller is configured to receive touch information from the touch detection apparatus, convert the touch information into contact point coordinates, send the coordinates to the processor 680, and receive commands sent by the processor 680 for executing. Furthermore, the touch-sensitive surface 631 can have various types including, e.g., resistive, capacitive, infrared, surface acoustic wave, etc.

In addition to, or alternative to the touch-sensitive surface 631, the input unit 630 may include other input devices 632. For example, the other input devices 632 can include, but are not limited to, e.g., one or more of physical keyboard, function keys (e.g., volume control keys, switch keys, power key, etc.), trackball, mouse, joystick, etc.

The display unit 640 is configured to display information entered by the user, information provided for the user, or various graphical user interfaces of the electronic device 600. The graphical user interfaces can be formed by graphics, text, icons, videos, or a combination thereof. The display unit 640 may include a display panel 641, optionally, configured using liquid-crystal display (LCD), organic light-emitting diode (OLED) and/or any other suitable display methods. Further, the touch-sensitive surface 631 can cover the display panel 641. When the touch-sensitive surface 631 detects a touch operation on or near the touch-sensitive surface 631, the touch-sensitive surface 631 can process the touch operation to generate data, and send the data to the processor 680 to determine the type of the touch event. The processor 680 can then provide a corresponding visual output on the display panel 641, according to the type of the touch event. Although the touch-sensitive surface 631 and the display panel 641 are depicted in FIG. 6 as two separate components to achieve input and output functions, in various embodiments, the touch-sensitive surface 631 can be integrated with the display panel 641 for the input and output functions.

The electronic device 600 may further include one or more sensors 650 including, e.g., light sensor, motion sensor, and/or other sensors. The light sensor may include an ambient light sensor and/or a proximity sensor. The ambient light sensor can adjust brightness of the display panel 641 according to the brightness of ambient light. The proximity sensor can turn off the display panel 641 and/or backlighting when the electronic device 600 is moved to be close to ear. As a type of motion sensor, a gravity acceleration sensor may detect magnitude of acceleration in each direction (e.g., three-axis), and can detect magnitude and direction of gravity when still. Thus, the gravity acceleration sensor can be configured for applications of identify mobile phone postures (e.g., switching between horizontal and vertical screens, related games, magnetometer posture calibration), functions related to vibration recognition (e.g., pedometer, percussion), etc. The electronic device 600 can also be configured with gyroscope, barometer, hygrometer, thermometer, infrared sensor and other sensors.

The audio circuit 660, coupled with a speaker 661, a microphone 662 can provide an audio interface between the user and the electronic device 600. The audio circuit 660 is configured to transmit to the speaker 661 an electrical signal after a conversion from received audio data. The speaker 661 is configured to convert the electrical signal to audio signal output. On the other hand, the microphone 662 is configured to convert collected audio signal to an electrical signal. The audio circuit 660 can receive the electrical signal for converting to audio data. The audio circuit 660 can output the audio data to the processor 680 for processing, and the processed audio data can be sent to another terminal via the RF circuit 610. Alternatively, the audio data can be outputted to the memory 620 for further processing. The audio circuit 660 may also include an earphone jack to provide communication between a peripheral headset and the electronic device 600.

The short-range wireless transmission module 670 can include a WiFi module or a Bluetooth module. WiFi is a short-range wireless transmission technology. The electronic device 600 can help users to receive/send e-mail, browse web pages, and access streaming media, etc., via the short-range wireless transmission module 670. The short-range wireless transmission module 670 can be configured to provide wireless broadband Internet access. Although the short-range wireless transmission module 670 is depicted in FIG. 6, it is not essential to the electronic device 600, and can be omitted according to practical applications, without limitation.

The processor 680 can be a control center of the electronic device 600, and can be configured to connect various components of the electronic device 600 using various interfaces and circuits. By running or executing software programs and/or modules stored in the memory 620, and by retrieving data stored in the memory 620, the processor 680 can be configured to perform various functions of the electronic device 600 and process data in order for an overall control of the electronic device 600 (e.g., mobile phone). Optionally, the processor 680 may contain one or more processing cores. Optionally, the processor 680 may integrate an application processor and a modem processor. The application processor can be configured to process operating systems, user interfaces and application programs, etc. The modem processor can be configured to process wireless communications. Optionally, the modem processor is not integrated into the processor 680.

The electronic device 600 can further include a power supply or power supplies 690 (e.g., battery), to supply electric power to various components. Optionally, the power supply 690 can be connected to logic of the processor 680, via a power management system, and thus achieve functions including, e.g., charge/discharge management, power consumption management, etc. via the power management system. The power supply 690 may further include any other suitable components, e.g., one or more DC or AC power supplies, re-charging system, power failure detection circuit, power converter or inverter, power status indicator, and/or any other suitable components.

Although not shown in FIG. 6, the electronic device 600 can further include a camera, a Bluetooth module, etc. The electronic device 600 can further include a motor for generating vibration of the electronic device 600. In various embodiments, the electronic device 600 can include the memory 620. The memory 620 has one or more programs thereon stored in the memory 620. Via appropriate configuration of the electronic device 600, the one or more programs can be executed by the one or more processors 680 to perform the methods for moving target element in accordance with various disclosed embodiments.

For illustrative purposes, in certain embodiments, methods for moving target element can be used in a board game played on an electronic device. The electronic device can have a display unit. The display unit can display a display interface that includes a game board and any appropriate display area outside the game board. A target element can be a piece in the board game.

In one example, the method for moving a target element can be implemented on an electronic device that supports mouse operation. A selection signal can be received. The selection signal can be triggered via single clicking a left button on or near a piece on the display interface of the electronic device. The state of the piece on the display interface can be updated to a selected state according to the selection signal. In the selected state, the mouse and the piece can be displayed as a hand holding or grabbing the piece. Optionally, when the left button of the mouse is clicked, the displayed hand can have finger(s) bent for generating a realistic visual appearance of hand motion. The piece can be moved using the mouse, and the movement can form a movement signal. During the process of moving the piece, the left button of the mouse does not need to be held down continuously.

Further, during the movement of the piece, notification message of a target location can be displayed on the display interface following the movement signal. Thus, target location can be identified and determined easily, which can solve the problem of lines on the game board being blocked by pieces and thus being hard to identify.

Still further, the selected state of the piece can be displayed using an animation of the piece being grabbed and lifted by a hand. A predetermined distance and a predetermined angle can be maintained between the grabbed target element and the display interface, e.g., as in Step 202 and FIG. 2C.

During the process of moving the piece, the cursor of the mouse can be displayed as the hand holding the piece while being moved, and the left button of the mouse does not need to be held down continuously, e.g., as in Step 203 and FIG. 2D.

When the piece is moved to a target location, the left button of the mouse can be clicked to place the piece. When no another piece is at the target location, a vivid animation effect of banging or pounding the piece on the game board can be generated (e.g., the first animation as described in Sub-step 207b). When another piece is at the target location, the left button of the mouse can be clicked to place the piece and capture the another piece. In this case, a vivid animation effect can be generated, including banging or pounding the piece on the to-be-captured piece, withdrawing the to-be-captured piece from beneath, and quickly placing the to-be-captured piece to outside the game board (e.g., the second animation as shown in Sub-step 207c, FIG. 2J).

In addition, when the user clicks on a location on the display interface that does not match preset rule, and thus the piece cannot be placed at the location, the piece can be returned to the original location, e.g., as shown in Step 206. During movement of the piece, when the user desires to operate an element or controls outside the display interface of the electronic device, the user can move the piece, i.e., the piece that is being moved, to outside the game board. When the distance between the piece and the game board is greater than or substantially equal to a preset distance (e.g., about the diameter of a piece), the piece can be automatically returned to the original location, e.g., as shown in FIG. 2K, and the mouse can change back to a normal shape (e.g., a normal hand shape) instead of a hand grabbing the piece.

In another example, the method for moving a target element can be implemented on an electronic device that has a touch screen and supports point-clicking or single-tapping operation on the touch screen. The selected state of the piece can be displayed using an animation of the piece being grabbed and lifted by a hand. A predetermined distance and a predetermined angle can be maintained between the grabbed target element and the display interface, e.g., as in Step 302 and FIG. 3C.

When the piece is moved to a target location, the target location can be tapped or single clicked to place the piece. An animation of moving the piece from the original location to the target location can be displayed. After the moving, the original location can be marked, e.g., by a circle, and the piece moved to the target location can be marked, e.g., by glowing on the outer edge of the piece.

When another piece is at the target location, the piece on the touch screen can be clicked to place the piece and capture the another piece. In this case, a vivid animation effect can be generated, including banging or pounding the piece on the to-be-captured piece, withdrawing the to-be-captured piece from beneath, and quickly placing the to-be-captured piece to outside the game board (e.g., the second animation as shown in Sub-step 3 of Step 307).

In addition, when the user clicks on a location on the display interface that does not match preset rule, and the piece cannot be placed at the location, the piece can be returned to the original location, e.g., as depicted in Step 306.

In certain embodiments, the electronic device can be a mobile terminal having a touch screen, and the disclosed methods can be used in a board game (e.g., Chinese chess game) played on an electronic device. Optionally, in an ‘in-check’ situation, a checkmate situation, or a piece-capturing operation, a vibration effect of the electronic device can be generated when vibration function of the electronic device is on.

In certain embodiments, the electronic device can be any suitable device. In an ‘in-check’ situation or a checkmate situation, certain effects can be generated. The effects can include playing a user-interface prompt or user-interface indication. The prompt or indication can be audio and/or visual. The effects can further include shaking the game interface, i.e., the game board.

Part or all of the steps in the methods in accordance with various embodiments can be accomplished using hardware, or using a program/software to instruct related hardware. The program/software can be stored in a non-transitory computer-readable storage medium including, e.g., ROM/RAM, magnetic disk, optical disk, etc.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

The disclosed methods, apparatus and electronic devices can be used in a variety of Internet applications including, e.g., any operations on an electronic device that involves human-computer interaction involving information input-output. The operations can include, but are not limited to, games, online transaction, and computer-aided interactive learning.

As disclosed in the exemplary method for moving a target element, a selection signal can be received. The state of a target element on a display interface can be updated to a selected state according to the selection signal. A movement signal that is linked after the selection signal can be received. A notification message of a target location can be displayed on the display interface following the movement signal. A confirmation signal that is linked after the movement signal can be received. The target element can be moved to the target location based on the confirmation signal. Therefore, problems of high error rate during a process of moving target element can be solved. Such problems can cause the operating process to consume a long time and reduce the lifetime of battery-powered electronic devices. Thus, by continuously and dynamically displaying notification message of a target location according to changes of a movement signal, a user can intuitively and clearly determine where a target location is during a process of moving. The error rate during the process of moving target element can be reduced. The time consumed by the operating process can be reduced. Consumption of electric power can be reduced.

Further, in the methods for moving target element in accordance with various embodiments, by displaying a selected state of the target element, the selected target element can be more easily distinguished from other elements on the display interface. By receiving a movement signal linked after the selection signal while the left button of the mouse does not need to be held down continuously during the process of moving the target element, the left button of the mouse does not need to be held down continuously, and the target element can still be displayed when being moved with the mouse without blocking other elements on the display interface. In addition, by displaying a target element having a predetermined transparency at the original location of the target element, the user can more easily know where the original location of the target element is located on the display interface.

Still further, in the methods for moving target element in accordance with various embodiments, by displaying notification message at a current matching target location, the user can more easily know at which location on the display interface to place the target element currently being moved. By displaying at least one candidate target location, locations matching preset rule(s) can be determined more accurately and quickly. Thus, time can be saved and accuracy can be improved. By keeping the target element at the original location when there is no current matching target location, the target element is not placed at an incorrect location thus to cause confusion on the display interface. By moving the target element to the target location, and by moving another target element from the target location to another predefined location or cancelling the displaying of the another target element, the target element can replace the another target element. Thus, there is no need to delete the another target element or move the another target element again. Complexity of operation can thus be reduced, and time can be saved.

What is claimed is:

1. A method for moving a target element, implemented on an electronic device having a display unit, wherein the display unit displays a display interface, comprising:
receiving a selection signal;
updating a state of a target element on the display interface as a selected state according to the selection signal;
receiving a movement signal linked after the selection signal;
displaying a notification message of a target location following the movement signal on the display interface;
receiving a confirmation signal linked after the movement signal; and
moving the target element to the target location based on the confirmation signal.

2. The method according to claim 1, wherein the displaying of the notification message of the target location following the movement signal on the display interface includes:
determining at least one candidate target location according to a preset rule;
following the movement signal to determine a current matching target location from the at least one candidate target location; and
displaying the notification message at the current matching target location, the notification message including a graphic mark, an arrow mark, a lightening mark, an animation effect, or a combination thereof.

3. The method according to claim 1, wherein the selection signal includes a clicking signal triggered at a location instructed by a cursor pointing to the target element, and wherein the updating of the state of the target element on the display interface as the selected state according to the selection signal includes:
updating the cursor and the target element that the cursor points to into a display state including a hand shape grabbing the target element, wherein the grabbed target element and the display interface have a predetermined distance and a predetermined angle maintained therebetween.

4. The method according to claim 1, wherein, after receiving the movement signal linked after the selection signal, the method further includes:
changing a cursor moved by the movement signal into a display state including a hand shape grabbing the target element.

5. The method according to claim 1, wherein, after receiving the movement signal linked after the selection signal, the method further includes:
displaying the target element having a predetermined transparency at an original location of the target element.

6. The method according to claim 5, wherein the displaying of the target element having the predetermined transparency at the original location of the target element includes:
calculating a distance between the original location and a location indicated by the movement signal;
determining whether the distance reaches a predetermined threshold value; and
when the distance does not reach the predetermined threshold value, displaying the target element having a dynamic transparency at the original location according to the distance, wherein the distance has a negative correlation with the dynamic transparency; or
when the distance reaches the predetermined threshold value, displaying the target element having a static transparency at the original location according to the distance, wherein the static transparency is a predefined value.

7. The method according to claim 1, wherein the moving of the target element to the target location based on the confirmation signal includes:
determining whether another target element exists at the target location;
when that no another target element exists at the target location is determined, moving the target element to the target location; and
when that the another target element exists at the target location is determined:
moving the target element to the target location; and
moving the another target element to another predefined location or cancelling displaying of the another target element.

8. The method according to claim 7, wherein, before moving the target element to the target location, the method further includes:
displaying a first animation, wherein the first animation includes dropping the target element onto the target location.

9. The method according to claim 7, wherein, after moving the target element to the target location, the method further includes:
displaying the notification message on one or both of an original location of the target element and a moving track of the target element, wherein the notification message includes the graphic mark, the arrow mark, the lightening mark, the animation effect, or a combination thereof.

10. The method according to claim 7, wherein, before moving the target element to the target location and moving the another target element to the another predefined location or cancelling the displaying of the another target element, the method further includes:
displaying a second animation, wherein the second animation includes:
dropping the target element on the another target element;
withdrawing the another target element from between the target location and the target element;
moving the another target element to the another predefined location or cancelling the displaying of the another target element; and
dropping the target element on the target location.

11. The method according to claim 2, wherein, after receiving the confirmation signal linked after the movement signal, the method further includes:
when the current matching target location does not exist, keeping the target element on the original location.

12. The method according to claim 1, wherein, after moving the target element to the target location based on the confirmation signal, the method further includes:
detecting whether a pre-defined condition is triggered after the target element is moved to the target location; and
when that the pre-defined condition is triggered is detected, performing at least one of:
playing a third animation, wherein the third animation includes displaying a pre-defined character and shaking the display interface or a predetermined region on the display interface;
generating a prompt sound; and
vibrating the electronic device.

13. An apparatus for moving a target element, comprising:
a first receiving module configured to receive a selection signal;
a state-updating module configured to update a state of a target element on a display interface to a selected state according to the selection signal received by the first receiving module;
a second receiving module configured to receive a movement signal linked after the selection signal received by the first receiving module;
a notification-displaying module configured to display a notification message of a target location on the display interface following the movement signal;
a third receiving module configured to receive a confirmation signal linked after the movement signal; and
an element-moving module configured to move the target element to the target location based on the confirmation signal.

14. The apparatus according to claim 13, wherein the notification-displaying module includes:
a location-determining unit configured to determine at least one candidate target location according to a preset rule;
a match-determining unit configured to follow the movement signal to determine a current matching target location from the at least one candidate target location; and
a notification-displaying unit configured to display the notification message at the current matching target location, the notification message including a graphic mark, an arrow mark, a lightening mark, an animation effect, or a combination thereof.

15. The apparatus according to claim 13, wherein the selection signal includes a clicking signal triggered at a location instructed by a cursor pointing to the target element, and the state-updating module is configured to:
update the cursor and the target element pointed to by the cursor into a display state including a hand shape grabbing the target element, wherein the grabbed target element and the display interface have a predetermined distance and a predetermined angle maintained therebetween.

16. The apparatus according to claim 13, further including:
a shape-changing module configured to change a cursor moved by the movement signal into a display state including a hand shape grabbing the target element.

17. The apparatus according to any one of claims 13 and 14, further including:
an element-displaying module, configured to display the target element having a predetermined transparency at an original location of the target element.

18. The apparatus according to claim 17, wherein the element-displaying module includes:
a distance-calculating unit configured to calculate a distance between the original location and a location indicated by the movement signal;
a threshold-value-determining unit configured to determine whether the distance reaches a predetermined threshold value;
a first displaying unit configured to, when the distance does not reach the predetermined threshold value, display the target element having a dynamic transparency at the original location according to the distance, wherein the distance has a negative correlation with the dynamic transparency; and
a second displaying unit configured to, when the distance reaches the predetermined threshold value, display the target element having a static transparency at the original location according to the distance, wherein the static transparency is a predefined value.

19. The apparatus according to claim 13, wherein the element-moving module includes:
an element-determining unit configured to determine whether another target element exists at the target location;
a first moving unit configured to, when that no another target element exists at the target location is determined, move the target element to the target location; and
a second moving unit configured to, when that the another target element exists at the target location is determined:
move the target element to the target location; and
move the another target element to another predefined location or cancel displaying of the another target element.

20. The apparatus according to claim 19, wherein the element-moving module further includes:
a first-animation-displaying unit configured to display a first animation, wherein the first animation includes the target element being dropped onto the target location.

21. The apparatus according to claim 19, wherein the element-moving module further includes:
a notification-displaying unit configured to display the notification message on one or both of an original location of the target element and a moving track of the target element, wherein the notification message includes the graphic mark, the arrow mark, the lightening mark, the animation effect, or a combination thereof.

22. The apparatus according to claim 19, wherein the element-moving module further includes:
a second-animation-displaying unit configured to display a second animation, wherein the second animation includes:
dropping the target element on the another target element;
withdrawing the another target element from between the target location and the target element;
moving the another target element to the another predefined location or cancelling the displaying of the another target element; and
dropping the target element on the target location.

23. The apparatus according to claim 14, further including:
a location-keeping unit configured to, when the current matching target location does not exist, keep the target element at the original location.

24. The apparatus according to claim 13, further including:
a condition-detecting module configured to detect whether a pre-defined condition is triggered after the target element is moved to the target location; and
an animation-playing module configured to, when that the pre-defined condition is triggered is detected, perform at least one of:
playing a third animation, wherein the third animation includes displaying a pre-defined character and shaking the display interface or a predetermined region on the display interface;
generating a prompt sound; and
vibrating the electronic device.
